(19) United States
(12) Patent Application Publication
(10) Pub. No.: US 2004/0086620 A1
(43) Pub. Date: May 6, 2004

(54) Method for delivering flavor compounds to a beverage and a beverage comprising the flavor compounds

(75) Inventors: John William Tobin, Hillsdale, NJ (US); Gregg Lance Lehmberg, Westfield, NJ (US); June Qi-Zheng, Morganville, NJ (US)

Correspondence Address: UNILEVER, PATENT DEPARTMENT, 45 RIVER ROAD, EDGEWATER, NJ, 07020, US

(73) Assignee: Unilever Bestfoods North America

(21) Appl. No.: 10/283,823

(22) Filed: Oct. 30, 2002

(51) Int. Cl. A23F 3/00

(52) U.S. Cl. 426/597

(57) ABSTRACT

Fresh flavor is delivered to an on-premise beverage at the point of dispense. Flavor compounds are incorporated in a separate component and then the separated flavor component is mixed with beverage concentrate at the time of dispense to produce a superior beverage.

### FIELD OF THE INVENTION

The present invention is directed to a method for delivering flavor compounds to a beverage, like a tea based beverage, just prior to the dispensing of the beverage. More particularly, the present invention relates to a method in which flavor compounds are incorporated as a separate component or additive and then delivered to other beverage components within a beverage dispensing machine.

### BACKGROUND OF THE INVENTION

Tea, Camellia sinensis, originated in China around 220 B.C. and is enjoyed worldwide due to its unique aromatic flavor (aroma) and astringent taste. Tea is traditionally consumed as leaf (green, oolong or black) infused with hot water, either in loose form or in the form of a tea bag. As an alternative to fresh brewing, tea is also consumed in the form of instant tea powder which may be mixed with sugar, citric acid and natural flavors and reconstituted with water. Instant tea, however, while very convenient to use, is generally perceived as a lower quality tea than that brewed directly from the leaf.

Therefore, in restaurants, cafeteria, office coffee services, sports venues and the like, i.e., “on-premise”, tea leaf is generally brewed using various brewers to prepare fresh brewed iced tea beverages. However, the consistency and microbiological stability of such brewed tea is of great concern. As a result, a very concentrated tea extract (developed by Lipton, a division of Conopco, Inc.) which delivers iced tea more conveniently than brewing from tea leaf, which delivers the brewed tea character not attainable from powdered tea and which regularly produces a consistent, safe iced tea beverage, has been developed. The concentrate contains tea extract, colors, flavors, aromas, preservatives and acid and is diluted about 100-fold by dispensing equipment which has been specifically designed for reconstituting this tea concentrate to prepare an iced tea beverage on-premise. The dispensing equipment preferred for use in this invention and with such a concentrate is described in U.S. patent application Ser. No. 10/245,950 assigned to Unilever Bestfoods (by Tobin et al.), the disclosure of which is incorporated herein by reference.

The above-mentioned tea concentrate is made via tea processing. In general, tea processing refers to a process of treating or extracting tea leaf to obtain maximum yield of tea solids with minimum negative change to the tea flavor/character. Tea solids refer to the dry matter of a tea extract of which the largest class of compounds comprises polyphenols. Tea processing typically consists of five steps, namely extraction, aroma stripping, de-creaming, concentration and spray drying. The above-mentioned concentrated tea extract (concentrate) is prepared by extracting, aroma stripping, de-creaming and concentrating tea solids. U.S. Pat. Nos. 6,423,362, 6,423,361 and 6,413,570 relate to the above-described tea concentrate, and the disclosure of each of these patents is incorporated by reference herein.

After selecting the raw leaf material, tea is extracted with water by percolation or countercurrent extraction. After extraction, a de-creaming step takes place in order to remove insoluble materials that form in tea extract upon cooling; tea extract is typically cooled and centrifuged in order to remove the insoluble material, which would otherwise be responsible for cloudiness or haze in the final beverage upon reconstitution. The de-creamed extract is then concentrated by evaporation under vacuum to produce a concentrate usually at 20% to 75% tea solids or higher. Additional concentration steps such as reverse osmosis and freeze drying may also or may alternatively be used. Tea processing steps and manufacture are described in detail in “Tea and Soluble Tea Products Manufacture” by Nicholas Pintauro (Noyes Data Corporation, Park Ridge, N.J., 1977).

The above-mentioned tea concentrate is stabilized and preserved and can be used in conventional dispensing equipment, but is preferably used with the equipment mentioned above to prepare iced tea beverages on-premise. However, it has been discovered that this tea concentrate may fail to deliver the volatile, aromatic compounds necessary to deliver fresh brewed tea taste beyond approximately 3-5 days.

These volatile, aromatic compounds, collectively referred to as tea aroma, are essential to tea quality, aroma, flavor or a combination thereof (i.e., beverage enhancing compounds). The composition of tea aroma is rather complex, consisting of approximately 500-650 compounds including hydrocarbons, aldehydes, alcohols, esters, ketones, lactones, phenols, acids and nitrogen- and sulfur-containing compounds. A complete list of tea aroma compounds discovered to date is set forth in “TEA, Cultivation to Consumption”, Wilson and Clifford, Chapman Hall, London (1992). Scientists have found it difficult to identify specific key compounds that characterize tea aroma, and it is believed that even compounds present at very small quantities may play a key role in tea aroma.

It has been discovered that certain critical chemical components of tea aroma and tea flavors, in particular, the aldehydes, may be unstable in the presence of concentrated tea solids. Therefore, these components can degrade rapidly in the above-mentioned tea concentrate. The exact degradation mechanism is not known; however, aldehydes have been shown analytically to degrade by more than 90% of the original value within one week.

It is of increasing interest to develop a method to deliver a beverage having flavor and aroma compounds that have not been degraded. This invention, therefore, is directed to a method for delivering flavor compounds, aroma compounds or both to a beverage just prior to dispensing the same from beverage dispensing equipment.

### SUMMARY OF THE INVENTION

The present invention is directed to a method for delivering fresh brewed taste to an on-premise beverage at a point of dispense comprising the steps of: (a) delivering at least one flavor compound (like tea flavor compound) in an amount sufficient to deliver fresh brewed taste separate from that delivered by beverage concentrate prior to the time of dispense of the beverage; and (b) mixing the flavor compound with the concentrate or a concentrate and water mixture at the time of dispense.

In certain preferred embodiments of the invention, the flavor compound includes compounds that generate tea flavor, tea aroma or both tea flavor and tea aroma. Tea aroma typically comprises less than about 1.0% by weight of the previously referenced 500-600 compounds. In additional preferred embodiments, the flavor compound is provided in an amount of 0.001 to 12%, more preferably, 0.02 to 5%, and most preferably, 0.03 to 2% by weight of finished beverage, like iced tea beverage. In still additional preferred embodiments of the present invention, the flavor compound is provided in an amount from 0.1 to 150%, more preferably, 5 to 90%, and most preferably 15 to 75% of an amount of concentrate solids (e.g., tea solids) in a finished beverage (e.g., iced tea beverage).

The invention is also more generally directed to a method of delivering fresh flavor to an on-premise beverage at a point of dispense comprising the steps of: (a) providing at least one unstable component of the on-premise beverage separate from beverage components in which the at least one unstable component is unstable prior to the time of dispense; and (b) mixing the at least one unstable component with the beverage components in which the at least one unstable component is unstable at the time of dispense.

The invention is further directed to an on-premise iced tea beverage having fresh brewed tea taste made by the process comprising the steps of: (a) providing tea flavor compounds in an amount sufficient to deliver fresh brewed tea taste separate from tea solids prior to the time of dispense; and (b) mixing the tea flavor compounds with the tea solids at the time of dispense.

### DETAILED DESCRIPTION OF THE INVENTION

The present invention solves the problem associated with the degradation of unstable flavor components in the presence of other beverage ingredients, e.g., the degradation of tea aroma or tea flavor in a tea concentrate which contains tea solids. According to the present invention, flavor compounds are incorporated in a separate component and then the separated flavor component is mixed with beverage concentrate or a mixture of beverage concentrate and water at the time of dispense. It is important to note that the present invention is generally applicable to all on-premise beverages. Any unstable component may be delivered separately, e.g., via a 5-gallon bag suitable for use in certain dispensers, and then fresh dosed at the point of dispense into a given beverage.

As used herein, “tea aroma” refers collectively to the large group of naturally occurring, volatile, aromatic compounds essential to tea quality and flavor and are sourced directly from the leaf or the extract thereof. As used herein, “tea flavors” refers to artificially-made or naturally sourced compounds that are combined in certain ratios to simulate tea taste. As used herein, “tea flavor compounds” refers to tea aroma or a component thereof, tea flavor or a component thereof or a combination thereof. As used herein, “on-premise” refers to all locations where food or beverage is consumed out of the home such as restaurants, cafeteria, office coffee services and sports venues. At the time of dispense means within the beverage dispensing equipment and just before beverage is to exit the dispensing equipment.

What is claimed is:

1. A method for delivering fresh beverage taste to an on-premise beverage at a point of dispense comprising the steps of:
(a) delivering at least one flavor compound in an amount sufficient to deliver fresh taste separate from beverage concentrate prior to the time of dispense; and
(b) mixing the flavor compound with water or the beverage concentrate or a beverage concentrate and water mixture at the time of dispense.

2. The method of claim 1 wherein the flavor compound is a tea flavor compound that comprises tea flavor, tea aroma or a combination thereof.

3. The method of claim 2 wherein the tea flavor compound is delivered in an amount of from about 0.001 to 12% by weight of finished beverage.

4. The method of claim 3 wherein the tea flavor compound is delivered in an amount of 0.02 to 5% by weight of finished beverage.

5. The method of claim 4 wherein the tea flavor compound is delivered in an amount of 0.03 to 2% by weight of finished beverage.

6. The method of claim 1 wherein the tea flavor compound is delivered in an amount from 0.1 to 150% of an amount of tea solids in the beverage concentrate.

7. The method of claim 6 wherein the tea flavor compounds are provided in an amount from 5 to 90% of an amount of tea solids in the beverage concentrate.

8. The method of claim 6 wherein the tea flavor compound is delivered in an amount from 15 to 75% of an amount of tea solids in the beverage concentrate.

9. A beverage prepared from:
(a) beverage concentrate;
(b) water; and
(c) flavor compounds separate from flavor compounds in the beverage concentrate.

10. The beverage according to claim 9 wherein the beverage is iced tea.

11. The beverage according to claim 10 wherein the tea is iced tea.
